(19) United States
(12) Patent Application Publication
(10) Pub. No.: US 2025/0297534 A1
(43) Pub. Date: Sep. 25, 2025

(54) SYSTEM AND METHOD FOR COMPOSITE MUDMAT AND MOUNTING BASE

(71) Applicant: Baker Hughes Energy Technology UK Limited, Bristol (GB)

(72) Inventors: Giovanni Biffaroni, Florence (IT); Michelangelo Fabbrizzi, Prato (IT); Leonardo Lani, Florence (IT); Kristoffer Økland, Oslo (NO); Mathias Berg, Oslo (NO); Cayo Murilo Pedroso Wagnitz, Florence (IT)

(73) Assignee: Baker Hughes Energy Technology UK Limited, Bristol (GB)

(21) Appl. No.: 19/085,818

(22) Filed: Mar. 20, 2025

Related U.S. Application Data
(60) Provisional application No. 63/568,694, filed on Mar. 22, 2024.

(51) Int. Cl. E21B 43/017; E02B 17/00; E02D 27/52; E21B 33/037

(52) U.S. Cl. CPC E21B 43/017; E02D 27/52; E21B 33/037; E02B 2017/0082; E02D 2300/0006

(57) ABSTRACT

A subsea assembly includes a mudmat formed using a composite material within a first mold and a mounting base, coupled to the mudmat, formed using the composite material within a second mold. The subsea assembly further includes one or more metallic components coupled to apertures formed in at least one of the mudmat or the mounting base, the one or more metallic components associated with one or more cathodic protection systems. The mudmat and the mounting base including physical dimensions and one or more component coupling features particularly selected based, at least in part, on one or more operating conditions and the composite material.

### CROSS-REFERENCE TO RELATED APPLICATIONS

This application claims priority to and the benefit of U.S. Provisional Patent Application No. 63/568,694, filed Mar. 22, 2024, the full disclosure of which is incorporated by reference herein in its entirety for all purposes.

### BACKGROUND

### 1. Field of the Disclosure

The present disclosure relates to wellbore operations. Specifically, the present disclosure relates to systems and methods for subsea operations for umbilical connections.

### 2. Description of Related Art

Oil and gas operations may be conducted in a variety of environments, such as subsea or surface environments, where components are installed on a rig or sea floor. In subsea operations, various umbilicals may extend between different components, for example, to provide electric or optical connections between various components. The umbilicals may be coupled to one or more umbilical termination assemblies (UTAs), which may be positioned and arranged at the sea floor. Generally, the UTAs are supported by a mudmat and a mounting base to secure the UTA near the wellbore. The mudmat and mounting base are usually an assembly configuration that includes various metallic components that are welded together into a desired configuration. The components are often challenging to assemble, deploy, and use in operation.

### SUMMARY

Applicant recognized the problems noted above herein and conceived and developed embodiments of systems and methods, according to the present disclosure, for mudmat and mounting base assemblies.

In an embodiment, a subsea assembly includes a mudmat formed using a composite material within a first mold. The subsea assembly also includes a mounting base, coupled to the mudmat, formed using the composite material within a second mold. The subsea assembly further includes one or more metallic components coupled to apertures formed in at least one of the mudmat or the mounting base, the one or more metallic components associated with one or more cathodic protection systems. The mudmat and the mounting base including physical dimensions and one or more component coupling features particularly selected based, at least in part, on one or more operating conditions and the composite material.

In an embodiment, a subsea support structure includes a composite mudmat and a composite mounting base. The composite mudmat includes a top surface, a skirt, a rounded edge at a transition between the top surface and the skirt, and a void space formed below the top surface extending to a bottom of the skirt. The composite mounting base includes a support surface, one or more arms extending axially higher than the support surface, and sloped sides extending from the support surface to the composite mudmat. The composite mounting base is positioned on the composite mudmat.

In another embodiment, a method includes providing a mold corresponding to one or more features of a subsea assembly. The method also includes forming the one or more features, within the mold, using a composite material. The method further includes moving the one or more features from the mold. The method also includes positioning the one or more features at a subsea location. The method includes coupling an associated subsea system to the one or more features.

### BRIEF DESCRIPTION OF DRAWINGS

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

FIG. 1 is a schematic side view of an embodiment of an offshore drilling operation, in accordance with embodiments of the present disclosure;

FIGS. 2A and 2B illustrate isometric views of an embodiment of a subsea assembly, in accordance with embodiments of the present disclosure;

FIGS. 3A and 3B illustrate side elevational views of an embodiment of a subsea assembly, in accordance with embodiments of the present disclosure;

FIG. 4 illustrates a cross-sectional view of an embodiment of a subsea assembly, in accordance with embodiments of the present disclosure;

FIG. 5 illustrates a bottom view of an embodiment of a subsea assembly, in accordance with embodiments of the present disclosure;

FIGS. 6A and 6B illustrate lifting configurations for an embodiment of a subsea assembly, in accordance with embodiments of the present disclosure; and

FIG. 7 is a flow chart of an embodiment of a method for forming and using a subsea assembly, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

Embodiments of the present disclosure are directed toward systems and methods for subsea assemblies, which may include mudmats and/or mounting bases. The subsea assemblies may include one or more composite components, such as those formed from an injection molding process. Accordingly, systems and methods may overcome problems with existing configurations with respect to long lead times for parts, lead times for manufacturing, lead time for non-destructive examination (NDE), and/or the like. Furthermore, embodiments may be used to provide a lighter, less costly, more readily available, system that may also reduce overall carbon emissions due to substituting various metallic material operations with one or more alternative processes, such as injection molding, among other options.

Embodiments of the present disclosure may be directed toward a subsea assembly that includes a mudmat and a mounting base that may be used to receive and support one or more UTAs. The subsea assembly may be formed from a composite material, which as a non-limiting example may be a glass reinforced polyester (GRP). GRP is provided as one example, and may be referred herein, but the present disclosure is not limited to the use of GRP and any material that can be used to create a part using, for example, injection molding may be incorporated within the scope of the present disclosure. Systems and methods may be directed toward a configuration that provides a unitary mudmat and mounting base, as well as systems that include multiple components forming one or both of the mudmat and mounting base that are coupled together. Embodiments may further be directed toward a composite mudmat and mounting base that may reduce the use of metallic components associated with the subsea assembly while providing various mounting configurations to permit coupling of one or more metallic meetings and/or the UTAs for use in a subsea application.

Various embodiments of the present disclosure may address and overcome problems associated with existing subsea assemblies, such as mudmats and mounting configurations. For example, UTA mudmat foundations are historically designed to be manufactured in a yard using structural steel with high fabrication cost driven mainly by welding and NDE activities. Accordingly, the cycle time (e.g., time to obtain the parts, manufacture the components, and ship) is generally long with high risks to increase the initial cost and also the potential delays due to scheduling during yard fabrication. Furthermore, the likelihood of errors increases due to the various welding operations that are performed. Systems and methods of the present disclosure may be used to reduce the cycle time and make the product more competitive by moving from the traditional steel to composite material technologies. Furthermore, embodiments may also help decarbonisation efforts by reducing the use of various metallic components and their associated manufacturing processes. Accordingly, as discussed herein, embodiments may provide an improved subsea assembly that uses a composite mudmat and mounting base to provide a reduced cycle time, lower weight, and reduced cost, along with reduced carbon emissions.

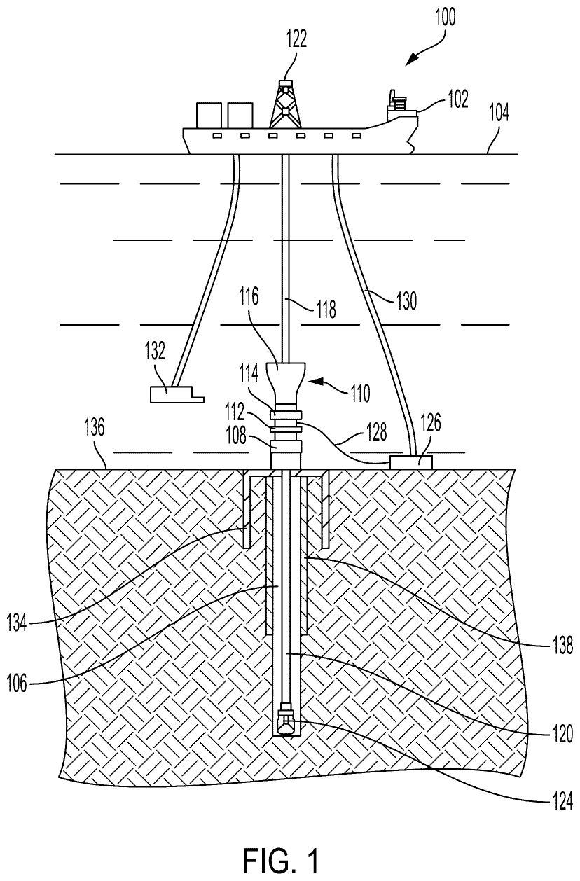

FIG. 1 is a side schematic view of an embodiment of a subsea drilling operation 100. It should be appreciated that one or more features have been removed for clarity with the present discussion and that removal or inclusion of certain features is not intended to be limiting, but provided by way of example only. Furthermore, while the illustrated embodiment describes a subsea drilling operation, it should be appreciated that one or more similar processes may be utilized for surface applications and, in various embodiments, similar arrangements or substantially similar arrangements described herein may also be used in surface applications. Furthermore, a drilling application is provided as a non-limiting example and various systems or methods could also be used in other applications, including recovery, inspection, data collection, and/or the like. The drilling operation includes a vessel 102 floating on a sea surface 104 substantially above a wellbore 106. As noted, the vessel 102 is for illustrative purposes only and systems and methods may further be illustrated with other structures, such as floating/fixed platforms, and the like. A wellbore housing 108 sits at the top of the wellbore 106 and is connected to a blowout preventer (BOP) assembly 110, which may include shear rams 112, sealing rams 114, and/or an annular ram 116. One purpose of the BOP assembly 110 is to help control pressure in the wellbore 106. The BOP assembly 110 is connected to the vessel 102 by a riser 118. During drilling operations, a drill string 120 passes from a rig 122 on the vessel 102, through the riser 118, through the BOP assembly 110, through the wellhead housing 108, and into the wellbore 106. It should be appreciated that reference to the vessel 102 is for illustrative purposes only and that the vessel may be replaced with a floating/fixed platform or other structure. The lower end of the drill string 120 is attached to a drill bit 124 that extends the wellbore 106 as the drill string 120 turns. Additional features shown in FIG. 1 include a mud pump 126 with mud lines 128 connecting the mud pump 126 to the BOP assembly 110, and a mud return line 130 connecting the mud pump 126 to the vessel 102. A remotely operated vehicle (ROV) 132 can be used to make adjustments to, repair, or replace equipment as necessary. Although a BOP assembly 110 is shown in the figures, the wellhead housing 104 could be attached to other well equipment as well, including, for example, a tree, a spool, a manifold, or another valve or completion assembly.

One efficient way to start drilling a wellbore 106 is through use of a suction pile 134. Such a procedure is accomplished by attaching the wellhead housing 108 to the top of the suction pile 134 and lowering the suction pile 134 to a sea floor 136. As interior chambers in the suction pile 134 are evacuated, the suction pile 134 is driven into the sea floor 136, as shown in FIG. 1, until the suction pile 134 is substantially submerged in the sea floor 136 and the wellhead housing 108 is positioned at the sea floor 136 so that further drilling can commence. As the wellbore 106 is drilled, the walls of the wellbore are reinforced with concrete casings 138 that provide stability to the wellbore 106 and help to control pressure from the formation. It should be appreciated that this describes one example of a portion of a subsea drilling operation and may be omitted in various embodiments. In at least one embodiment, systems and methods of the present disclosure may be used for drilling operations that are completed through a BOP and wellhead, where a casing hanger and string are landed in succession. As noted above, configurations with respect to a sea floor or any offshore application are for illustrative purposes and embodiments of the present disclosure may also be utilized in surface drilling applications.

Various embodiments of the present disclosure incorporate one or more subsea assemblies, which may include, at least in part, mudmats and/or mounting bases that are formed, at least in part, from composite materials. Accordingly, as discussed herein, systems and methods may provide for a lower cost, lower cycle time, lighter weight subsea assembly that may be particularly selected and formed for a variety of subsea applications. In at least one embodiment, the assembly may include a mounting base that is integrally formed with a mudmat, for example, during one or more manufacturing processes, such as injection molding. Embodiments may also include components that are coupled together, for example using one or more fasteners. In at least one embodiment, the subsea assembly may be configured to operate with existing downhole equipment, such as existing UTAs, and therefore, may be used to retrofit and or be incorporated into designs without expensive reformulation or redesign of components. Additionally, one or more molds may be modified or reconfigured for new UTA designs, for example, by adding various inserts or the like, thereby providing improved flexibility.

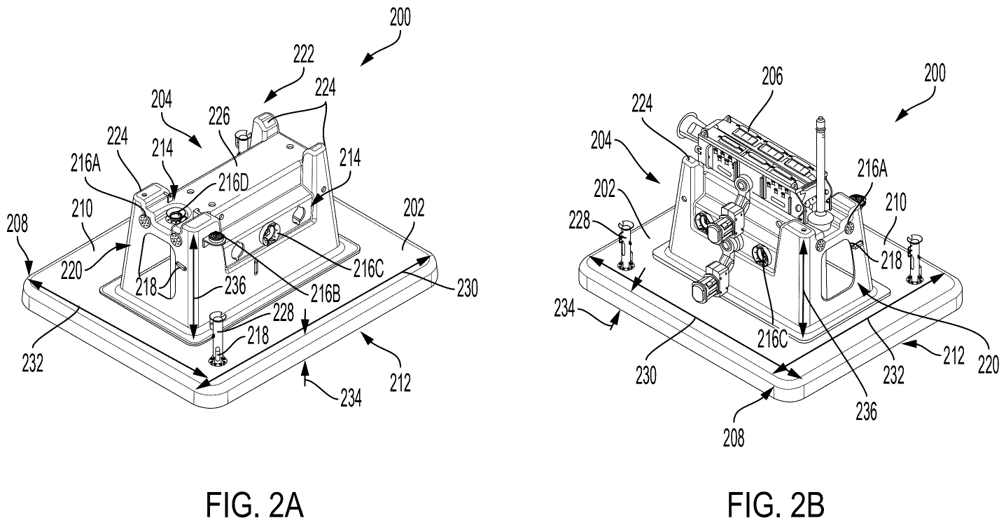

FIGS. 2A and 2B are isometric views of an embodiment of a subsea assembly 200, which may be used with embodiments of the present disclosure. In the example configurations, the subsea assembly 200 includes a mudmat 202 and a mounting base 204. Furthermore, as shown in FIG. 2B, a UTA 206 may be coupled to the mounting base 204. The illustrated configuration of the subsea assembly 200 includes, at least in part, composite materials in the formation of the mudmat 202 and the mounting base 204. Embodiments may include unitary components such that the mudmat 202 and the mounting base 204 are formed within a common mold or as part of a common process, which may include a transition between the mudmat 202 and the mounting base 204, as shown in FIGS. 2A and 2B. The illustrated transition is curved, which may reduce stresses between the mudmat 202 and the mounting base 204. The molding process may further cause the transition to include a platform or raised edge between the mudmat 202 and the mounting base 204. While embodiments may discuss the use of molds, such as injection molding, it should be appreciated that various other manufacturing processes may be used within the scope of the present disclose, such as additive manufacturing, compression molding, blow molding, rotational molding, casting, and/or the like.

In this example, the illustrated mudmat 202 includes curved edges 208 between a top surface 210 and a skirt 212 that is used to contact a location, such as the sea floor. The curved edges 208 may be in the form of one or more radii that are arranged at a transition between the top surface 210 and the skirt 212. Use of the curved edges 208 may beneficially reduce stresses during the manufacturing process and also provide improved strength and flexibility during operation, as opposed to the squared edges typically found with existing mudmats and mounting bases. As discussed herein, the skirt 212 may include a walled structure that is used to position the top surface 210 over the sea floor. It should be appreciated that various ribs (not pictured) or other components may be arranged below the top surface 210 and extend down to the sea floor, along with the skirt 212. Furthermore, various inserts may be included based on the expected operating conditions. For example, particular soils may be identified and then different configurations, inserts, and/or the like may be used based, at least in part, on the soil at the landing location for the mudmat 202.

The illustrated mounting base 204 is shown integrally formed with the mudmat 202, but it should be appreciated that the mounting base 204 may be coupled to the mudmat 202, for example, using one or more fasteners, adhesives, interference fits, clips, and/or the like. In certain embodiments, additional components may be added to facilitate coupling of components, such as backing plates, seals, shims, washers, and/or the like. The mounting base 204 includes various apertures 214 along different sides and at different positions to incorporate one or more connectors 216. The connectors 216 may include, as non-limiting examples, ROV docketing receptables 216A, a bullseye 216B, a multi-quick connect (MQC) stab plate 216C, a guidepost receptacle 216D, and/or the like. Furthermore, as discussed herein, various metallic components 218 may be coupled to or otherwise arranged on one or both of the mudmat 202 and/or the mounting base 204 to serve as anodes for cathodic protection systems.

The configuration of the mounting base 204 in FIGS. 2A and 2B, shown by way of non-limiting example, further includes an opening 220, which may be used to reduce an overall weight of the system. For example, the walls of the mounting base 204 may be particularly selected to have a thickness to provide sufficient support and strength for the UTA 206, as well as to accommodate the stresses and pressure of extreme environments, such as subsea environments as a non-limiting example.

Various embodiments may further include a mounting configuration 222 that is selected to receive and support the UTA 206. For example, one or more arms 224 may extend vertically above a support 226 to block movement (e.g., axial, lateral, transverse, rotational) of the UTA 206. Additionally, the arms 224 may be guides or otherwise lead the UTA 206 to one or more locations to facilitate landing and coupling to the mounting base 204. For example, the UTA 206 may be lowered or guided to the mounting base 204 at a subsea location and the arms 224 can be used to direct or otherwise restrict movement prior to securing the UTA 206 to the mounting base 204. For example, the illustrated embodiment includes slanted surfaces on the arms 224 that may be used to guide the UTA 206, or other component, to the support 226.

The embodiment shown in FIGS. 2A and 2B further illustrates additional components that may be associated with various subsea assemblies, such as a transponder bucket 228, which as discussed herein, may include one or more metallic components 218 for use in cathodic protection systems. In this example, the transponder bucket 228 may be a metallic component that is secured to the mudmat 202 using one or more fasters and may further include gaskets, backing plates, and other components to enable the attachment. While two transponder buckets 228 are shown in the example, there may be more or fewer.

Systems and methods of the present disclosure may include the mudmat 202 and/or the mounting base 204 with configurable dimensions that may be based, at least in part, on anticipated operating conditions. For example, the type or model of the UTA 206 may determine selection of components of one or both of the mudmat 202 and the mounting base 204. Similarly, conditions at the seabed, such as the soil type, depth, temperature, and/or the like may also be used to select one or more dimensions, such as a mudmat length 230, a mudmat width 232, a mudmat depth 234, a mounting base height 236, and/or the like. Furthermore, various other dimensions may be modified, such as the mudmat 202 having a generally rectangular shape, a generally square shape, a pill shape, and/or any other reasonable shape.

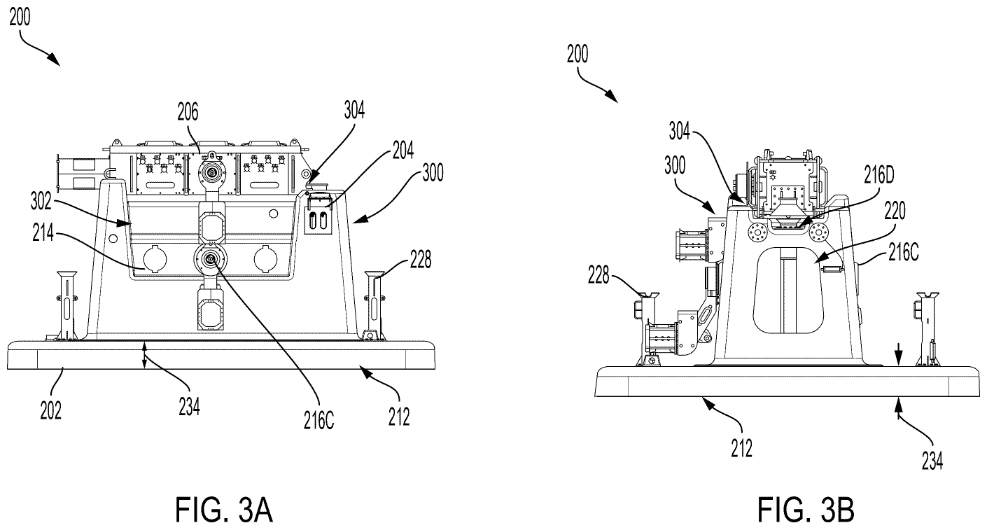

FIGS. 3A and 3B illustrate side elevational views of embodiments of the subsea assembly 200, including the mudmat 202, the mounting base 204, and the UTA 206. In this example, the mounting base 204 is illustrated as having sloped sides 300 that are angled such that the mounting base 204 is narrower at a top location (e.g., near the support 206) than at a lower location (e.g., near the top surface 210). During manufacturing, one or more inserts may be positioned within the mold used to form the mounting base 204 to form the sloped sides and/or to provide a slope to facilitate demolding after formation. Further illustrated is a recessed portion 302 as part of the mounting base 204, which includes the MQC stab plates 216C. The recessed portion 302 may be positioned to reduce the weight to the system as a whole and/or to facilitate alignment between various connected components. For example, it may be desirable to arrange the MQC stab plates 216C in a substantially vertical configuration and providing the recessed portion 302 for connection may be useful in positioning and/or aligning the MQC stab plates 216C.

Various embodiments may include one or more locking elements 304 used to secure the UTA 206 to the mounting base 204. For example, the locking elements 304 may include one or more locking bolts that are rotatable about an axis to permit movement between an engaged position and a disengaged position. For example, a latch may be rotated out of contact with a blocking feature to permit movement of a shaft along the axis between the engaged and disengaged positions. Rotation in an opposite direction may move the latch into a position such that additional movement along the axis would be stopped by the blocking features. In at least one embodiment, the positions and locations of the one or more locking elements 304 may be particularly selected based on the UTA 206. For example, the locking elements 304 may be positioned to enable use with existing UTAs 206.

Further illustrated in FIGS. 3A and 3B are the transponder buckets 228, which may form a portion of a cathodic protection system. For example, anodes may be coupled to the transponder buckets 228 and/or coupled to steel portions of the mounting base 204. In this manner, corrosion protection may be integrated into the assembly. Additionally, FIG. 3B illustrates a guide post extending through the guidepost receptacle 216D.

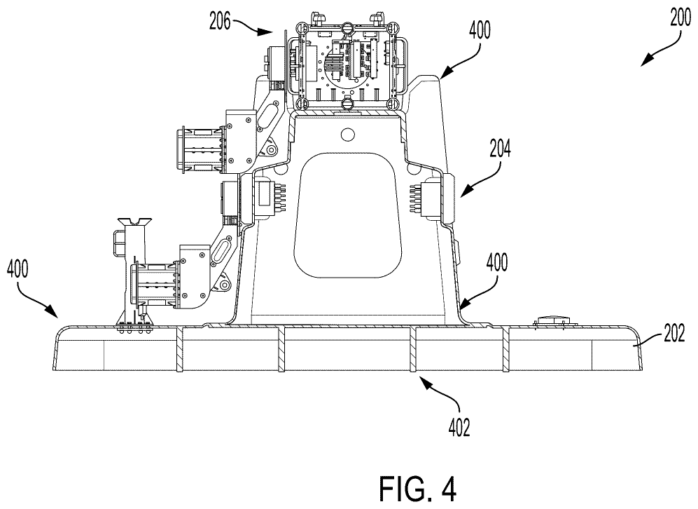

FIG. 4 illustrates a cross-sectional view of the subsea assembly 200. In this example, both the mudmat 202 and mounting base 204 are illustrated as substantially hollow components that include thin walls 400. The wall 400 may be any reasonable thickness and may be particularly selected based on one or more properties of the subsea assembly 200, such as expected operating conditions, expected weight of the UTA 206, and/or the like. As discussed, one or more embodiments may include a molding process, such as injection molding, that may facilitate the use of the thin walls 400, which may enable reduced weight and easier to manufacture components while maintaining desired strength properties.

This example further includes the non-limiting internal stiffeners 402 discussed herein, but it should be appreciated that the internal stiffeners 402 may be arranged in different configurations. In operation, the stiffeners 402 may be installed and particularly selected based on one or more operating conditions. For example, different expected surface configurations, flow rates, and/or the like may be used to design stiffeners 402 in different locations. Furthermore, the stiffeners 402 may be omitted in one or more embodiments where the skirt 212 may provide appropriate support. The stiffeners 402 may be arranged to extend across a length or width of the mudmat 202, or may be localized to particular regions.

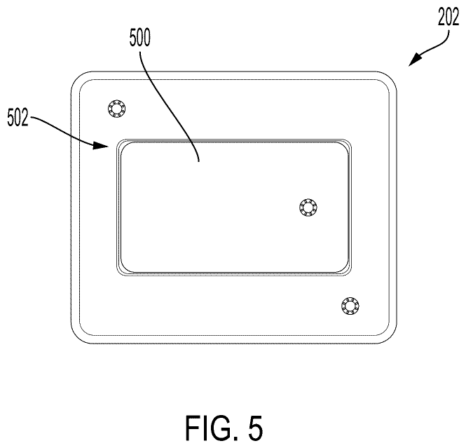

FIG. 5 illustrates a bottom view of the mudmat 202 that includes a bottom plate 500 to adjust the mudmat 202 stiffness. For example, a slot 502 may be formed within the mudmat 202 (e.g., on an opposite side of the top surface 210). In at least one embodiment, the bottom plate 500 may be inserted and secured into the slot 502. For example, the bottom plate 500 may be glued inside the slot 502. The bottom plate 500 may also be secured via fasteners, be press fit, or otherwise secured within the slot 502. In at least one embodiment, the bottom plate 500 is particularly selected to account for different expected operating conditions, such as soil conditions. In this manner, a bottom mudmat 202 may be used in a variety of different scenarios by replacing or modifying features of the bottom plate 500.

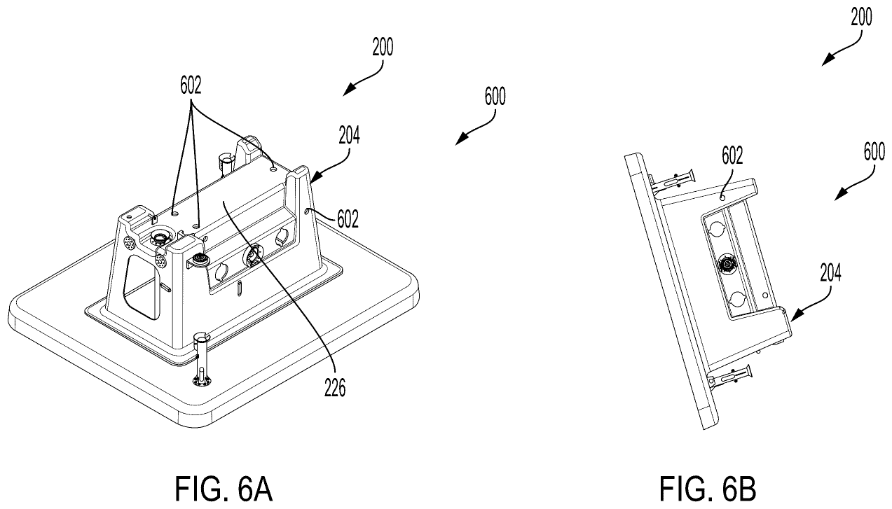

FIGS. 6A and 6B illustrate example lifting configurations 600 for the subsea assembly 200, including a horizontal lifting configuration (FIG. 6A) and a vertical lifting configuration (FIG. 6B). As shown, the mounting base 204 includes lifting points 602. The horizontal lifting configuration includes three lifting points 602 arranged along the support 226. It should be appreciated that more or fewer lifting points 602 may be including in various embodiments. The lifting configurations may be used for both onshore and subsea lifting and positioning.

Further illustrated is a lifting point 602 along a side of the mounting base 204. As a result, a vertical lifting configuration, as shown in FIG. 6B may be used for installation of the subsea assembly 200. For example, a second lifting point 602 (not shown) may be used to lower the subsea assembly 200 into position. The lifting configurations of FIGS. 6A and 6B may use fewer anchor points than those used with traditional systems due to the decreased size and weight and unique construction facilitated by the use of composite materials.

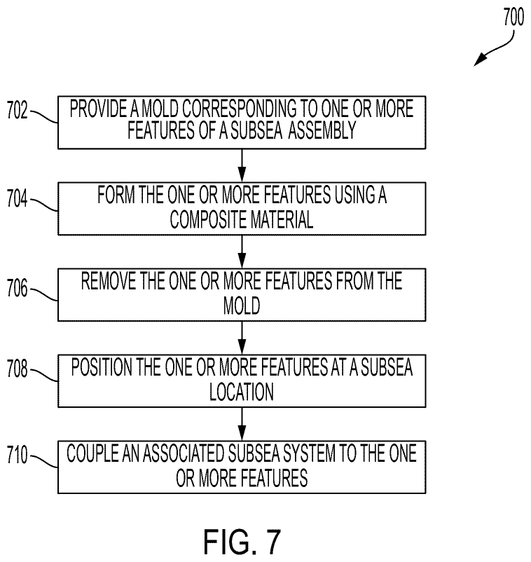

FIG. 7 illustrates an example flow chart of a method 700 for forming a subsea assembly. It should be appreciated that for this method, and all methods described herein, that there may be more or fewer steps or operations. Furthermore, steps may be performed in a different order, or in parallel, unless otherwise specifically stated. Additionally, different portions of the method may be conducted in uphole or downhole locations, on site or off site, or combinations thereof. In this example, a mold corresponding to one or more features for a subsea assembly is provided 702. The mold may include a mode for an injection molding system including a unitary part or multiple parts that are to be coupled together. The one or more features may then be formed within the mold using a composite material 704. For example, an injection molding process may use GRP to form the one or more features. In at least one embodiment, the one or more features are removed from the mold 706 and then the mold is used and during an operation, such as to land the mold at a subsea location 708. One or more associated subsea systems may then be coupled to the mold 710. Accordingly, various embodiments may facilitate the use of a composite system within a downhole environment to replace metallic components.

Embodiments may further be described with respect to the following clauses:
1. A subsea assembly, comprising:
a mudmat formed using a composite material within a first mold;
a mounting base, coupled to the mudmat, formed using the composite material within a second mold; and
one or more metallic components coupled to apertures formed in at least one of the mudmat or the mounting base, the one or more metallic components associated with one or more cathodic protection systems;
wherein the mudmat and the mounting base include physical dimensions and one or more component coupling features particularly selected based, at least in part, on one or more operating conditions and the composite material.
2. The subsea assembly of clause 1, wherein the first mold and the second mold form portions of a common mold.
3. The subsea assembly of clause 1, wherein the mudmat and the mounting base are integrally formed.
4. The subsea assembly of clause 1, wherein at least one of the mudmat or the mounting base is formed from a plurality of components coupled together.
5. The subsea assembly of clause 1, wherein the first mold and the second mold are associated with an injection molding process.
6. The subsea assembly of clause 1, wherein the composite material is glass reinforced polyester.
7. The subsea assembly of clause 1, wherein the one or more cathodic protection systems comprise:
at least one anode coupled to at least one of the mounting base or the mudmat; and
one or more steel parts coupled to the at least one anode.
8. The subsea assembly of clause 1, wherein the one or more cathodic protection systems comprise:
a transponder bucket secured to the mudmat; and
an anode coupled to the transponder bucket.
9. The subsea assembly of clause 1, wherein the mudmat comprises one or more stiffeners formed within a skirt.
10. The subsea assembly of clause 1, wherein the mudmat comprises:
one or more inserts positioned within an underside of the mudmat.
11. A subsea support structure, comprising:
a composite mudmat, comprising:
   a top surface;
   a skirt;
   a rounded edge at a transition between the top surface and the skirt; and
   a void space formed below the top surface extending to a bottom of the skirt; and
a composite mounting base, comprising:
   a support surface;
   one or more arms extending axially higher than the support surface; and
   sloped sides extending from the support surface to the composite mudmat;
wherein the composite mounting base is positioned on the composite mudmat.
12. The subsea support structure of clause 11, wherein the composite mudmat and the composite mounting base are integrally formed within a common mold.
13. The subsea support structure of clause 11, wherein the composite mudmat further comprises:
a slot; and
a bottom plate positioned within the slot.
14. The subsea support structure of clause 13, wherein one or more properties of the bottom plate are particularly selected based on operating conditions of the subsea support structure.
15. The subsea support structure of clause 11, wherein the composite mudmat further comprises:
one or more stiffeners positioned within the void space.
16. The subsea support structure of clause 11, wherein the composite mounting base further comprises:
one or more lifting points configured to position the subsea support structure at a subsea location.
17. The subsea support structure of clause 11, wherein the support surface is configured to receive one or more umbilical coupling systems.
18. The subsea support structure of clause 11, wherein the composite mounting base includes one or more openings configured to reduce an overall weight of the composite mounting base.
19. A method, comprising:
providing a mold corresponding to one or more features of a subsea assembly;
forming the one or more features, within the mold, using a composite material;
removing the one or more features from the mold;
positioning the one or more features at a subsea location; and
coupling an associated subsea system to the one or more features.
20. The method of clause 19, further comprising:
positioning a plate within a slot formed in a mudmat corresponding to at least a feature of the one or more features.
21. A subsea assembly, comprising:
a mudmat formed using a composite material within a first mold;
a mounting base, coupled to the mudmat, formed using the composite material within a second mold; and
one or more metallic components coupled to apertures formed in at least one of the mudmat or the mounting base, the one or more metallic components associated with one or more cathodic protection systems;
wherein the mudmat and the mounting base include physical dimensions and one or more component coupling features particularly selected based, at least in part, on one or more operating conditions and the composite material.
22. The subsea assembly of clause 21, wherein the first mold and the second mold form portions of a common mold.
23. The subsea assembly of either of clause 21 or clause 22, wherein the mudmat and the mounting base are integrally formed.
24. The subsea assembly of any of clauses 21-23, wherein at least one of the mudmat or the mounting base is formed from a plurality of components coupled together.
25. The subsea assembly of any of clauses 21-24, wherein the first mold and the second mold are associated with an injection molding process.
26. The subsea assembly of any of clauses 21-25, wherein the composite material is glass reinforced polyester.
27. The subsea assembly of any of clauses 21-26 wherein the one or more cathodic protection systems comprise:
at least one anode coupled to at least one of the mounting base or the mudmat; and
one or more steel parts coupled to the at least one anode.
28. The subsea assembly of any of clauses 21-27, wherein the one or more cathodic protection systems comprise:
a transponder bucket secured to the mudmat; and
an anode coupled to the transponder bucket.
29. The subsea assembly of any of clauses 21-28, wherein the mudmat comprises one or more stiffeners formed within a skirt.
30. The subsea assembly of any of clauses 21-29, wherein the mudmat comprises:
one or more inserts positioned within an underside of the mudmat.
31. A subsea support structure, comprising:
a composite mudmat, comprising:
   a top surface;
   a skirt;
   a rounded edge at a transition between the top surface and the skirt; and
   a void space formed below the top surface extending to a bottom of the skirt; and
a composite mounting base, comprising:
   a support surface;
   one or more arms extending axially higher than the support surface; and
   sloped sides extending from the support surface to the composite mudmat;
wherein the composite mounting base is positioned on the composite mudmat.
32. The subsea support structure of clause 31, wherein the composite mudmat and the composite mounting base are integrally formed within a common mold.
33. The subsea support structure of any of clauses 31 or 32, wherein the composite mudmat further comprises:
a slot; and
a bottom plate positioned within the slot.
34. The subsea support structure of clause 33, wherein one or more properties of the bottom plate are particularly selected based on operating conditions of the subsea support structure.
35. The subsea support structure of any of clauses 31-34, wherein the composite mudmat further comprises:
one or more stiffeners positioned within the void space.
36. The subsea support structure of any of clauses 31-35, wherein the composite mounting base further comprises:
one or more lifting points configured to position the subsea support structure at a subsea location.
37. The subsea support structure of any of clauses 31-36, wherein the support surface is configured to receive one or more umbilical coupling systems.
38. The subsea support structure of any of clauses 31-37, wherein the composite mounting base includes one or more openings configured to reduce an overall weight of the composite mounting base.
39. A method, comprising:
providing a mold corresponding to one or more features of a subsea assembly;
forming the one or more features, within the mold, using a composite material;
removing the one or more features from the mold;
positioning the one or more features at a subsea location; and
coupling an associated subsea system to the one or more features.
40. The method of clause 39, further comprising:
positioning a plate within a slot formed in a mudmat corresponding to at least a feature of the one or more features.

The foregoing disclosure and description of the disclosed embodiments is illustrative and explanatory of the embodiments of the invention. Various changes in the details of the illustrated embodiments can be made within the scope of the appended claims without departing from the true spirit of the disclosure. The embodiments of the present disclosure should only be limited by the following claims and their legal equivalents.

1. A subsea assembly, comprising:
a mudmat formed using a composite material within a first mold;
a mounting base, coupled to the mudmat, formed using the composite material within a second mold; and
one or more metallic components coupled to apertures formed in at least one of the mudmat or the mounting base, the one or more metallic components associated with one or more cathodic protection systems;
wherein the mudmat and the mounting base include physical dimensions and one or more component coupling features particularly selected based, at least in part, on one or more operating conditions and the composite material.

2. The subsea assembly of claim 1, wherein the first mold and the second mold form portions of a common mold.

3. The subsea assembly of claim 1, wherein the mudmat and the mounting base are integrally formed.

4. The subsea assembly of claim 1, wherein at least one of the mudmat or the mounting base is formed from a plurality of components coupled together.

5. The subsea assembly of claim 1, wherein the first mold and the second mold are associated with an injection molding process.

6. The subsea assembly of claim 1, wherein the composite material is glass reinforced polyester.

7. The subsea assembly of claim 1, wherein the one or more cathodic protection systems comprise:
at least one anode coupled to at least one of the mounting base or the mudmat; and
one or more steel parts coupled to the at least one anode.

8. The subsea assembly of claim 1, wherein the one or more cathodic protection systems comprise:
a transponder bucket secured to the mudmat; and
an anode coupled to the transponder bucket.

9. The subsea assembly of claim 1, wherein the mudmat comprises one or more stiffeners formed within a skirt.

10. The subsea assembly of claim 1, wherein the mudmat comprises:
one or more inserts positioned within an underside of the mudmat.

11. A subsea support structure, comprising:
a composite mudmat, comprising:
a top surface;
a skirt;
a rounded edge at a transition between the top surface and the skirt; and
a void space formed below the top surface extending to a bottom of the skirt; and
a composite mounting base, comprising:
a support surface;
one or more arms extending axially higher than the support surface; and
sloped sides extending from the support surface to the composite mudmat;
wherein the composite mounting base is positioned on the composite mudmat.

12. The subsea support structure of claim 11, wherein the composite mudmat and the composite mounting base are integrally formed within a common mold.

13. The subsea support structure of claim 11, wherein the composite mudmat further comprises:
a slot; and
a bottom plate positioned within the slot.

14. The subsea support structure of claim 13, wherein one or more properties of the bottom plate are particularly selected based on operating conditions of the subsea support structure.

15. The subsea support structure of claim 11, wherein the composite mudmat further comprises:
one or more stiffeners positioned within the void space.

16. The subsea support structure of claim 11, wherein the composite mounting base further comprises:
one or more lifting points configured to position the subsea support structure at a subsea location.

17. The subsea support structure of claim 11, wherein the support surface is configured to receive one or more umbilical coupling systems.

18. The subsea support structure of claim 11, wherein the composite mounting base includes one or more openings configured to reduce an overall weight of the composite mounting base.

19. A method, comprising:
providing a mold corresponding to one or more features of a subsea assembly;
forming the one or more features, within the mold, using a composite material;
removing the one or more features from the mold;
positioning the one or more features at a subsea location; and
coupling an associated subsea system to the one or more features.

20. The method of claim 19, further comprising:
positioning a plate within a slot formed in a mudmat corresponding to at least a feature of the one or more features.
